(19) United States
(12) Patent Application Publication
(10) Pub. No.: US 2008/0289460 A1
(43) Pub. Date: Nov. 27, 2008

(54) OXYGEN SENSOR SOCKET REMOVAL AND INSTALLATION TOOL

(75) Inventors: Michael L. Whitehead, Clarinda, IA (US); Michael J. Goodrich, Omaha, NE (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 11/970,565

(22) Filed: Jan. 8, 2008

Related U.S. Application Data
(63) Continuation-in-part of application No. 11/751,865, filed on May 22, 2007, now abandoned.

(51) Int. Cl. B25B 13/06; B25B 13/50

(52) U.S. Cl. 81/463; 81/52

(57) ABSTRACT

An oxygen sensor removal tool includes an axial throughbore with an oxygen sensor socket bore at one end and a socket drive bore at the opposite end, and further including a radially extending drive socket arm with a drive socket opening so that the tool may be placed over an oxygen sensor and a socket drive or other drive may be attached to the tool to provide for effective force to permit adequate torque to disengage the oxygen sensor from a vehicle exhaust system.

### CROSS REFERENCE TO RELATED APPLICATION

This is a continuation-in-part application of Ser. No. 11/751,865 filed May 22, 2007 entitle “Oxygen Sensor Socket Removal and Installation Tool” which is incorporated herewith by reference and for which priority is claimed.

### BACKGROUND OF THE INVENTION

In a principal aspect the present invention relates to a tool which may be used to remove and/or install an oxygen sensor typically mounted in a motor vehicle exhaust system. The tool is thus capable of utilization for the removal or replacement of an oxygen sensor located in restricted access location.

Modern motor vehicles include internal combustion engines which feature the utilization of an oxygen sensor. Data from the oxygen sensor is utilized by an onboard computer to effect more efficient internal combustion by the engine. Often it is necessary to replace the oxygen sensor. However, oxygen sensors have a tendency to become corroded and thus removal and replacement thereof in an exhaust system is often a difficult and/or a tedious undertaking. As a consequence, various socket and wrench constructions have been proposed which can be utilized to facilitate the removal of the oxygen sensors. While such prior tools are helpful and utilitarian, they are not necessarily always adequately useful. For example, they do not necessarily enable the user of such a tool to provide sufficient mechanical advantage or leverage in order to remove and/or replace the oxygen sensor. Thus, there has remained a need to provide an improved oxygen sensor socket tool.

### SUMMARY OF THE INVENTION

Briefly, the present invention comprises a tool for removal of an oxygen sensor from a motor vehicle exhaust system which includes a socket that is capable of receiving a socket drive either longitudinally or radially and which is designed to engage or fit over and engage the polygonal body of an oxygen sensor. The socket thus includes a body with a longitudinal axis throughbore having an oxygen sensor socket opening at one end. The oxygen sensor engaging socket is slotted for clearance of the oxygen sensor wire leads and is appropriately configured and sized on its outside periphery to avoid interference with the oxygen sensor exhaust system shields. A radial arm extends outwardly from the socket drive end of the sensor engaging socket and includes a radial and a longitudinal socket drive opening for receiving a socket drive, such as a square drive.

Thus, it is an object of the invention to provide an improved oxygen sensor socket tool.

It is a further object of the invention to provide an oxygen sensor removal tool which is useful for removal of various types, styles and shapes of motor vehicle oxygen sensors.

A further object of the invention is to provide a tool which permits ease of removal of an oxygen sensor wherein the tool is inexpensive, rugged, easy to use and enables access to a sensor in a location which may be otherwise difficult to access.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view of the tool as utilized in an operation to effect removal of an oxygen sensor depicting the manner of cooperation with socket drives or other drives to effect the utility of the tool;

FIG. 2 is a top plan view of an embodiment of the tool of the invention;

FIG. 3 is a side elevation of the tool of FIG. 2;

FIG. 4 is a further side elevation of the tool of FIG. 2 as viewed in the direction 4 in FIG. 2; and

FIG. 5 is an isometric view of the tool cooperative with a breaker bar.

### DESCRIPTION OF AN EMBODIMENT OF THE INVENTION

Referring to the figures, the tool for removal of an oxygen sensor from a vehicle exhaust system comprises a socket body 20 which includes a longitudinal centerline axis 22. The socket body 20 further includes an oxygen sensor engaging end or section 24 and a socket drive receiving end 26 located respectively coaxially at opposite ends of the body 20. The body 20 thus includes a throughbore 28 which is configured at the oxygen sensor engaging end 24 with an internal polygonal cross sectional bore configuration compatible with the outside configuration of an oxygen sensor. A longitudinal slot 25 in body 20 is provided for oxygen sensor lead wires. The oxygen sensor engagement end 24 further includes a generally circular outside peripheral surface 30 which has a diameter 32 in the range of 1.250±0.25 inches. Preferably, the nominal dimension of that surface 30 is 1.250 inches. This enables the removal tool to be utilized for the effective removal and/or replacement of oxygen sensors in a number of vehicle exhaust systems inasmuch as the internal configuration of the bore 28A at the oxygen sensor end 24 is compatible with an oxygen sensor and the outside surface 30 is sized so that the sensor can fit into an appropriate passage opening or configuration of the shielding of the exhaust system and engage an oxygen sensor.

The throughbore 28 further includes a drive engagement end 26 and associated bore 28B which has a polygonal configuration that may receive a socket drive. The bore 28B may be hexagonal and/or may be dual hexagonal or square, for example. The bore or bore section 28B will not typically receive a socket drive, but in the event the longitudinal dimension of body 20 is sufficient, a drive may be fitted into the bore section 28B.

The socket drive end 26 further includes an arm 34 projecting radially and generally transversely from the axis 22 with a longitudinal socket opening, such as the socket opening or bore 36, spaced radially from axis 22. Opening 36 is sized and shaped to receive a socket drive to effect turning of the removal tool and removal of an oxygen sensor.

The radial arm 34 also includes an internal, radially extending square socket drive bore 38 generally transverse to axis 22. Each bore 36, 38 may be distinctly sized. For example, bore 36 may be sized to receive a ⅜″ drive tool and bore 38 may be sized to receive a ½″ drive tool.

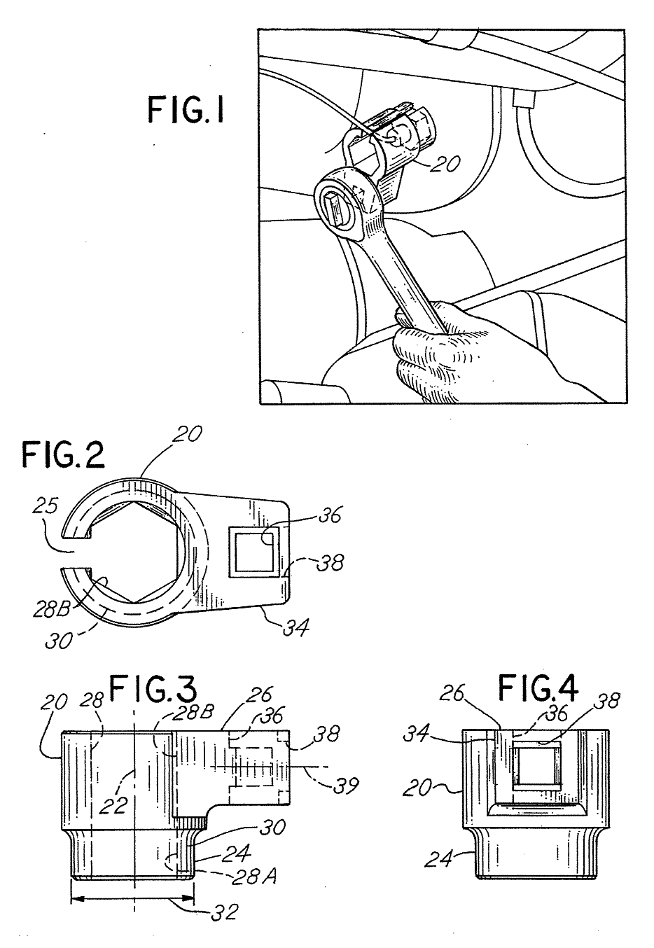

Thus, the tool may be constructed to receive multiple sizes and shapes of drives, both coaxially and radially and in that manner may be utilized with various drive mechanisms to effect removal and/or replacement of an oxygen sensor. FIG. 1 illustrates use of the tool with a socket wrench 50. Note that the outer ends of the body 20 are flat planar and perpendicular to the axis 22. Also axis 39 of bore 38 is perpendicular to axis 22. Slot 25 is radially opposite arm 34 and extends longitudinally for the length of the body 20. The slot 25 intersects and is generally perpendicular to a flat side of the hexagonal bore 28B to facilitate maintenance of strength of the tool as shown in FIG. 2.

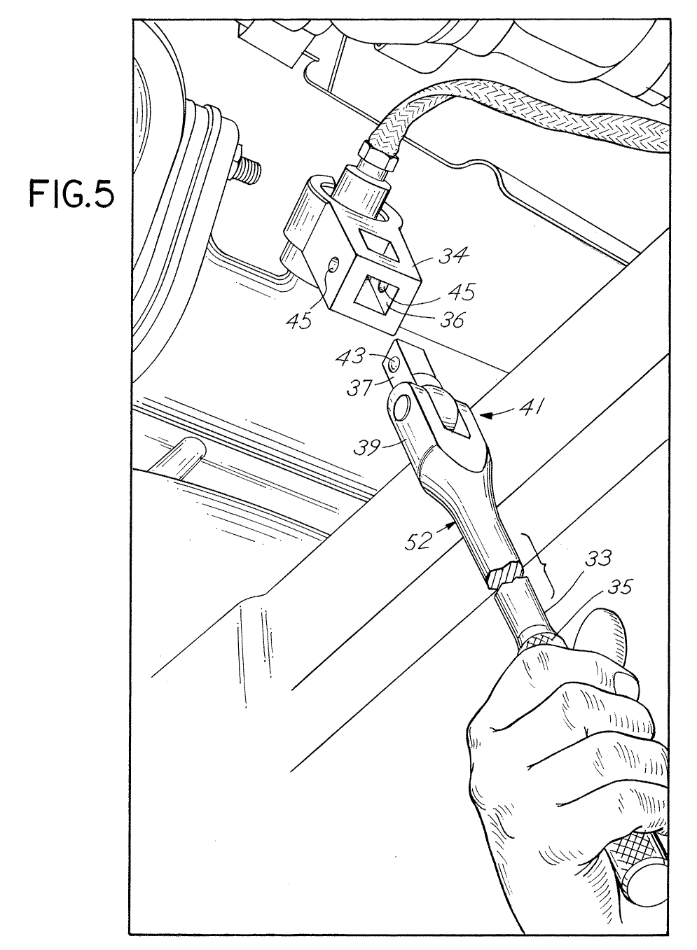

FIG. 5 illustrates use of the tool in combination with a breaker bar 52 which includes an elongate bar 33 with a knurled outer end 35 and a square drive 37 pivotally mounted in a clevis or fork 39 at the inner end 41. The fork 39 includes a biased ball construction 43 which may be positioned in alignment to engage passageways 45 formed in opposite sides of arm 34 when drive 37 is inserted into socket 36.

It is possible to amend or alter the shape and configuration of the arm 34 as well as the various socket drive openings without departing from the spirit and scope of the invention. The invention is therefore to be limited only by the following claims and equivalents thereof.

What is claimed is:

1. A tool useful for removal of an oxygen sensor of a motor vehicle comprising in combination:
a socket body having a longitudinal axis with a sensor engaging end, an opposite end, and a radial arm projecting radially from the opposite end transversely to the axis and;
a longitudinal throughbore in the body coaxial with the longitudinal axis, and a longitudinal slot through the body generally parallel to the axis;
an oxygen sensor socket bore compatible configuration at the sensor engaging end;
a first socket drive bore in the radial arm generally transverse to the axis; and
a second socket drive bore in the radial arm generally parallel to the longitudinal axis and radially spaced therefrom;
said sensor engaging end of said body having a generally circular outer configuration.

2. The tool of claim 1 wherein the outer configuration of the sensor engaging end has a diameter of about 1.250±0.25 inches.

3. The tool of claim 1 wherein the slot is generally on the opposite side of the longitudinal axis from the radial arm and is an axial slot extending the longitudinal dimension of the body.
